(19) United States
(12) Patent Application Publication
(10) Pub. No.: US 2012/0167711 A1
(43) Pub. Date: Jul. 5, 2012

(54) Clipless Pedal

(76) Inventor: Chin-Long Hsieh, Taichung City (TW)

(21) Appl. No.: 12/984,609

(22) Filed: Jan. 5, 2011

(51) Int. Cl. B62M 3/08

(52) U.S. Cl. 74/594.6

(57) ABSTRACT

A clipless pedal with a modularized engagement mechanism for detachably securing with the cleat on a rider's shoe is disclosed. The engagement structure includes a fixing seat, an annular frame, a depressor, two torsion springs, a shaft and a regulator bolt. The fixing seat is pivotally connected on the annular frame by inserting the shaft. The two torsion springs are put around the shaft. The depressor has a threaded hole in which the regulator bolt screws. By rotating the regulator bolt, the depressor can be linearly moved. Two ends of each the torsion separately bear against the fixing seat and depressor. The annular frame can be swung relative to the fixing seat when it is forced and restored by the torque from the torsion springs when it is not forced. The torque of the torsion springs can be regulated by linear movement of the depressor. The engagement mechanism can be fastened on a pedal body to form a clipless pedal.

### BACKGROUND OF THE INVENTION

1. Technical Field

The invention relates to bicycles, particularly to clipless pedals of bicycles.

2. Related Art

In recent years, bicycles have become very popular in the world. Beside the original purposes of competition and transportation, bicycling also serves for recreation. On the other hand, the popularization and diversification of bicycles also makes great advances in components and frames. One of the most advanced components is the clipless pedals.

A clipless pedal can be releasably engaged with a cleat fitted to a sole of a rider's shoe. The shoe and pedal will become integrated after the cleat has engaged with the pedal. This may improve the treading efficiency of the cyclists. There are so many clipless pedals with different structures in the market, such as U.S. Pat. Nos. 7,013,755, 6,520,048, 6,282,984 and 6,170,357. No matter what those structures are, in principle, they all assemble parts onto a pedal body. Such a pedal body requires to form many holes and complicated shapes. Thus, the pedal body must be manufactured with high accuracy. A small error of one of the parts may result in a defective product. Accordingly, the yield rate of the conventional clipless pedals is not good enough. And the manufacturing cost cannot be effectively reduced.

On the other hand, the pedal body and engagement mechanism of the conventional clipless pedals are completely assembled together. The engagement mechanism cannot exist independently and can fit only one type of pedal body. The engagement mechanism must be modified if the pedal body has been modified, and vice versa. Thus, it is so uneconomic to design or manufacture the conventional clipless pedals. There is a need for an improved clipless pedal.

### BRIEF DESCRIPTION OF THE DRAWINGS

FIG. 1 is an exploded view of the engagement mechanism of the invention;

FIG. 2 is an exploded view of the clipless pedal composed of a pedal body and two engagement mechanisms;

FIG. 3 is an assembled view of FIG. 2;

FIG. 4 is a cross-sectional view of FIG. 3;

FIGS. 5 and 6 show the process of engaging the cleat with the clipless pedal;

FIG. 7 is a top plan view the clipless pedal engaged with a cleat; and

FIG. 8 is a schematic view showing the engagement mechanism is fastened to another type of pedal body.

### SUMMARY OF THE INVENTION

An object of the invention is to provide a clipless pedal which employs a modularized engagement mechanism. The engagement mechanism is fastened to the pedal body after it has been assembled. This can simplify the manufacturing process and expand the permissible error of the pedal body. Thus the manufacturing cost and accuracy can be effectively reduced.

Another object of the invention is to provide a clipless pedal, which is economical in design and manufacture. The pedal of the invention employs a pedal body and a modularized engagement mechanism, which are independent from each other. Not only may the engagement mechanism fit various types of pedal bodies, but also the engagement mechanism and the pedal body may change their respective internal structures without associative involvement with the other party.

To accomplish the above objects, the engagement structure of the clipless pedal of the invention includes a fixing seat, an annular frame, a depressor, two torsion springs, a shaft and a regulator bolt. The fixing seat is pivotally connected on the annular frame by inserting the shaft. The two torsion springs are put around the shaft. The depressor has a threaded hole in which the regulator bolt screws. By rotating the regulator bolt, the depressor can be linearly moved. Two ends of each the torsion separately bear against the fixing seat and depressor. The annular frame can be swung relative to the fixing seat when it is forced and restored by the torque from the torsion springs when it is not forced. The torque of the torsion springs can be regulated by linear movement of the depressor. The engagement mechanism can be fastened on a pedal body to form a clipless pedal.

### DETAILED DESCRIPTION OF THE INVENTION

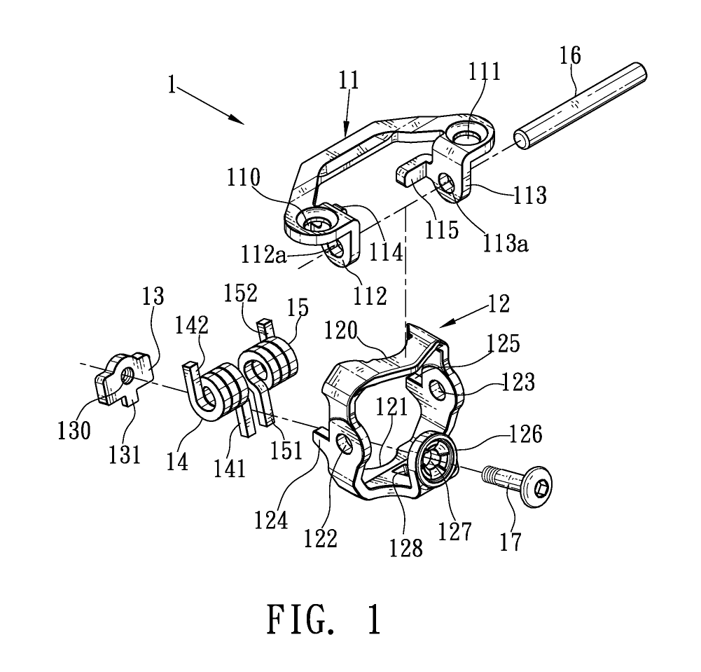

Please refer to FIG. 1, which is an exploded view of the modularized engagement mechanism of the clipless pedal of the invention. The engagement mechanism 1 includes a fixing seat 11, an annular frame 12, a depressor 13, two torsion springs 14, 15, a shaft 16 and a regulator bolt 17.

The fixing seat 11 is of a substantial C shape. Its two ends are separately provided with two fixing holes 110, 111 and two pivoting boards 112, 113 perpendicularly extending. Each of the pivoting boards 112, 113 is further provided with a pivoting hole 112a, 113a. Each of the pivoting boards 112, 113 is further perpendicularly extended with a blocking sheet 114, 115.

The annular frame 12 is approximately of a rectangular shape. An upper half and lower half of the annular frame 12 are formed into a front clamping member 120 and a rear clamping member 121, respectively. Two lateral sides of the annular frame 12 are separately provided with two shaft holes 122, 123 which are axially corresponding to each other and the pivoting holes 112a, 113a. The two pivoting boards 112,113 of the fixing seat 11 separately abut against the outside of the two shaft holes 122, 123 of the annular frame 12. The fixing seat 11 is pivotally connected to the annular frame 12 by inserting the shaft 16 into the pivoting holes 112a, 113a and the shaft holes 122, 123. The two lateral sides of the annular frame 12 are further separately extended with two protrusions 124, 125 abutting against the blocking sheets 114,115. Besides, the rear clamping member 121 of the annular frame 12 is perpendicularly extended with a hole seat 126 having a through hole 127 for being penetrated by the regulator bolt 17. There is an insertion hole 128 in the bottom of the annular frame 12.

The depressor 13 is provided with a threaded hole 130 for being screwed by the regulator bolt 17. The bottom edge of the depressor 13 is formed with an insertion pin 131 being linearly movably inserted into the insertion hole 128. The depressor 13 may be linearly moved in the insertion hole 128 by rotating the regulator bolt 17.

The two torsion springs 14, 15 are put around the shaft 16. The depressor 13 is leant against by a terminal 141, 151 of each the torsion spring 14, 15. The other terminal 142,152 of each torsion spring 14, 15 is blocked by one of the blocking sheets 114, 115. By this arrangement, the torsion springs 14, 15 may normally exert a force onto the fixing set 11 and annular frame 12. The elasticity of the torsion springs 14, 15 may be varied by rotating the regulator bolt 17. The more the depressor 13 moves towards the hole seat 126, the more the depressor 13 presses the torsion springs 14, 15 to generate larger elasticity. Contrarily, the elasticity will be reduced when the depressor 13 moves away from the seat hole 126. The adjustment of elasticity of the torsion spring 14, 15 depends upon users' individual requirements.

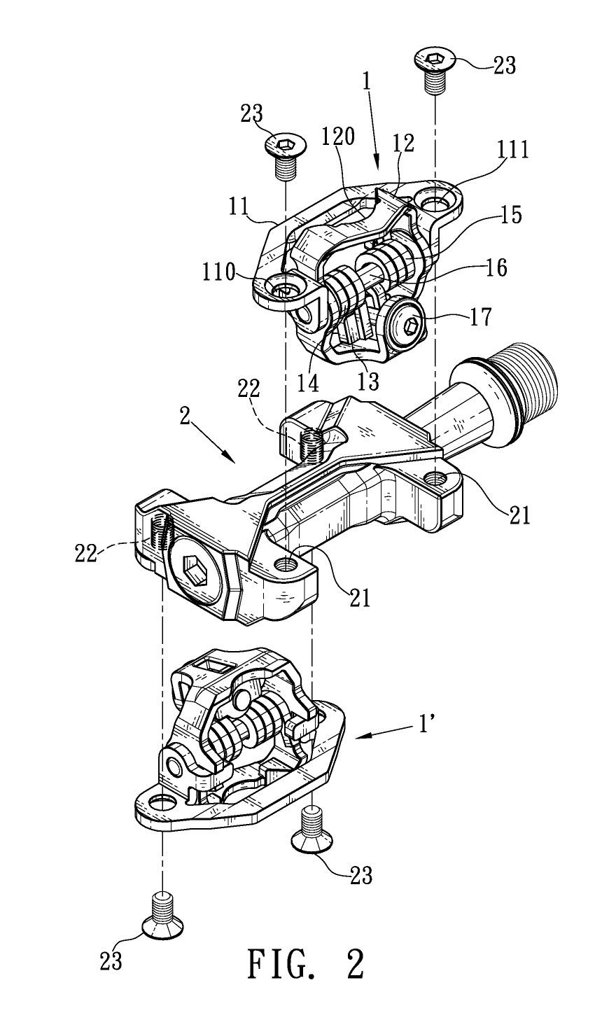

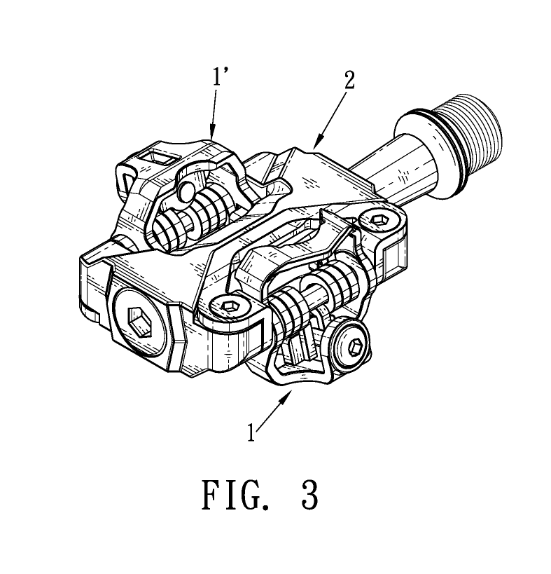

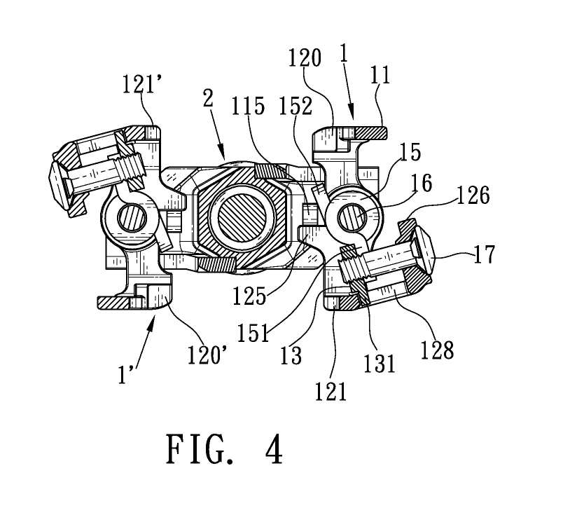

As shown in FIG. 2, the modularized engagement mechanism 1 is used to be fastened to a pedal body 2. A complete clipless pedal is composed of a pedal body 2 and two engagement mechanisms 1, 1′. Two engagement mechanisms 1, 1′ are oppositely symmetrically fastened to the pedal body 2. Each side of the pedal body 2 is provided with two fastening holes 21, 22 corresponding to the fixing holes 110, 111. The engagement mechanism 1 or 1′ is fastened to the pedal body 2 by fastening screws 23 into the fixing holes 110,111 and the fastening holes 21, 22. FIGS. 3 and 4 are a perspective view and a cross-sectional view of the clipless pedal with two engagement mechanisms 1, respectively.

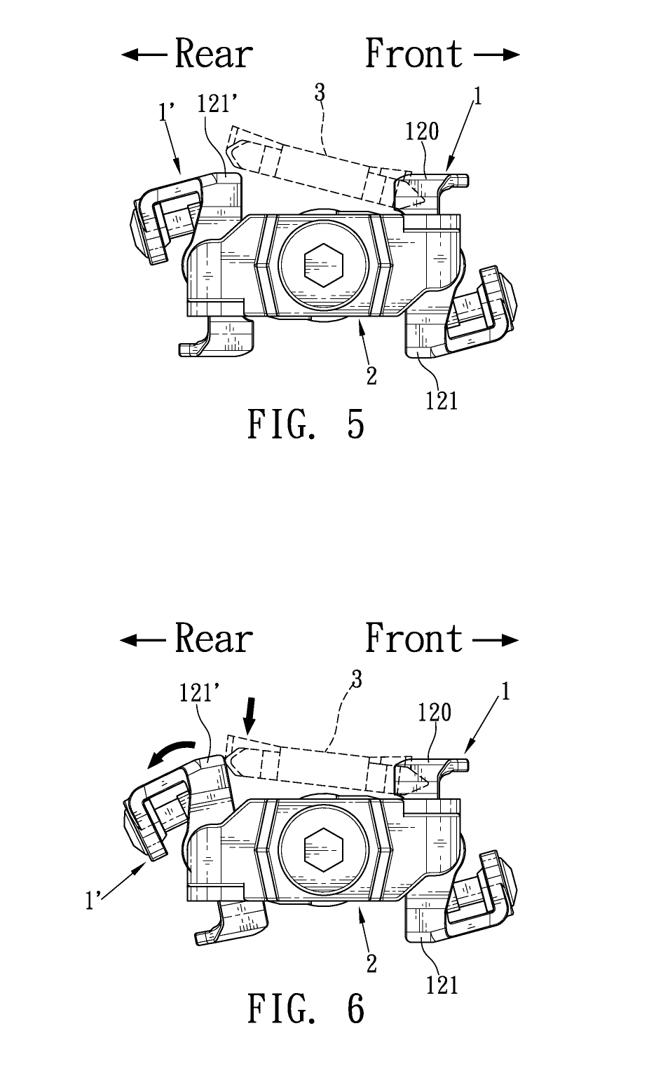

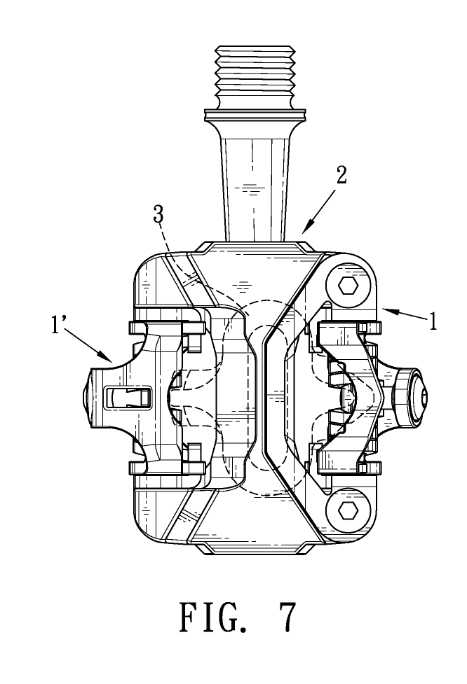

Please refer to FIGS. 5 and 6. Two engagement mechanisms 1, 1′ protrude from a surface of the pedal body 2 for clamping a cleat 3 on a rider's shoe. In these two figures, the right side is front (i.e. the direction of tiptoe) and the left side is rear (i.e. the direction of heel). The front of the cleat 3 is first embedded into the front clamping member 120 of the annular frame 12 of the front engagement mechanism 1. Then the rider treads with his/her heel to force the rear clamping member 121′ of the rear engagement mechanism 1′ to swing rearwards. The rear of the cleat 3 can be clamped in the rear clamping member 121′ while the rear clamping member 121′ is being swung rearwards. The engagement mechanisms 1, 1′ can rotate in only one direction because the protrusions 124, 125 are blocked by the blocking sheets 114, 115. That is, the front clamping member 120 of the front engagement mechanism 1 can swing only rearwards but cannot swing frontwards. Thus the front clamping member 120 is prevented from swinging frontwards while the cleat 3 is moving forward. On the other hand, a elasticity from the torsion springs 14, 15 is exerted on the engagement mechanism 1 or 1′ while the engagement mechanism 1 or 1′ is being forced to swing. When the rear of the cleat 3 has completely entered into the rear clamping member 121′, the force exerted on the rear clamping member 121′ from the cleat 3 disappears and the rear engagement mechanism 1′ will automatically restore to its original position because of the elasticity of the torsion springs 14, 15. After that, the cleat 3 is clamped by the front clamping member 120 and the rear clamping member 121′ as shown in FIG. 7.

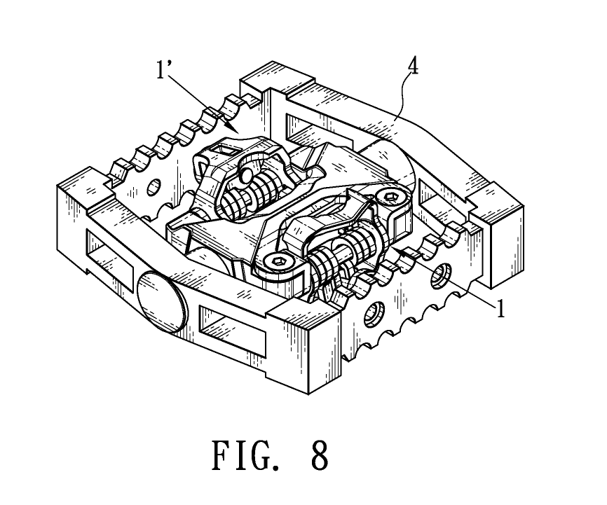

The engagement mechanism 1 or 1′ is an independent modularized structure, so it can be fastened to various pedal bodies. As shown in FIG. 8, the engagement mechanism 1 or 1′ is fastened to a normal flat pedal body 4. Of course, the type or shape of the pedal bodies is not limited to this. Other pedal bodies are also available.

While the forgoing is directed to various embodiments of the present invention, other and further embodiments of the invention may be devised without departing from the basic scope thereof. As such, the appropriate scope of the invention is to be determined according to the claims.

What is claimed is:

1. An engagement mechanism for a clipless pedal, comprising:
a fixing seat, having two pivoting boards and two blocking sheets, wherein each the pivoting board is provided with a pivoting hole axially corresponding to each other;
an annular frame, having an upper half and lower half, which are formed into a front clamping member and a rear clamping member respectively, two lateral sides of the annular frame being separately provided with two shaft holes axially corresponding to each other and separately extended with two protrusions abutting against the blocking sheets, the rear clamping member of the annular frame being extended with a hole seat having a through hole for being penetrated by a regulator bolt, and a bottom of the annular frame being provided with an insertion hole, wherein the two pivoting boards of the fixing seat separately abut against an outside of the two shaft holes of the annular frame, and the fixing seat is pivotally connected to the annular frame by inserting a shaft into the pivoting holes and the shaft holes;
a depressor having a threaded hole for being screwed by the regulator bolt and an insertion pin linearly movably inserted into the insertion hole, wherein the depressor is linearly moved in the insertion hole by rotating the regulator bolt; and
two torsion springs put around the shaft, wherein the depressor is leant against by a terminal of each the torsion spring, and the other terminal thereof is blocked by the fixing seat, so that the torsion springs normally exert a force on the fixing seat and the annular frame and normally retain a specific angle between the fixing seat and the annular frame.

2. The engagement mechanism of claim 1, wherein the fixing seat is of a substantial C shape, and the fixing seat is provided with two fixing holes at two ends thereof.

3. The engagement mechanism of claim 2, wherein the two pivoting boards perpendicularly extend from two ends of the fixing seat.

4. The engagement mechanism of claim 1, wherein the two blocking sheets separately perpendicularly extend from the pivoting boards.

5. The engagement mechanism of claim 1, wherein the annular frame is approximately of a rectangular shape.

6. The engagement mechanism of claim 1, wherein the other terminal of each the torsion spring is blocked by one of the blocking sheets.

7. A clipless pedal comprising:
a pedal body having two opposite sides; and
two engagement mechanisms, oppositely symmetrically fastened on the two sides of the pedal body, each of the engagement mechanisms comprising:
a fixing seat, having two pivoting boards and two blocking sheets, wherein each the pivoting board is provided with a pivoting hole axially corresponding to each other;
an annular frame, having an upper half and lower half, which are formed into a front clamping member and a rear clamping member respectively, two lateral sides of the annular frame being separately provided with two shaft holes axially corresponding to each other and separately extended with two protrusions abutting against the blocking sheets, the rear clamping member of the annular frame being extended with a hole seat having a through hole for being penetrated by a regulator bolt, and a bottom of the annular frame being provided with an insertion hole, wherein the two pivoting boards of the fixing seat separately abut against an outside of the two shaft holes of the annular frame, and the fixing seat is pivotally connected to the annular frame by inserting a shaft into the pivoting holes and the shaft holes;
a depressor having a threaded hole for being screwed by the regulator bolt and an insertion pin linearly movably inserted into the insertion hole, wherein the depressor is linearly moved in the insertion hole by rotating the regulator bolt; and
two torsion springs put around the shaft, wherein the depressor is leant against by a terminal of each the torsion spring, and the other terminal thereof is blocked by the fixing seat, so that the torsion springs normally exert a force on the fixing seat and the annular frame and normally retain a specific angle between the fixing seat and the annular frame.

8. The clipless pedal of claim 7, wherein each the side of the pedal body is provided with two fastening holes, the fixing seat is provided with two fixing holes corresponding to the fastening holes, and the engagement mechanism is fastened to the pedal body by fastening screws into the fixing holes and the fastening holes.

9. The clipless pedal of claim 7, wherein the fixing seat is of a substantial C shape, and the fixing seat is provided with two fixing holes at two ends thereof.

10. The clipless pedal of claim 9, wherein the two pivoting boards perpendicularly extend from two ends of the fixing seat.

11. The clipless pedal of claim 7, wherein the two blocking sheets separately perpendicularly extend from the pivoting boards.

12. The clipless pedal of claim 7, wherein the annular frame is approximately of a rectangular shape.

13. The clipless pedal of claim 7, wherein the other terminal of each the torsion spring is blocked by one of the blocking sheets.
